(19) United States
(12) Patent Application Publication
(10) Pub. No.: US 2024/0340859 A1
(43) Pub. Date: Oct. 10, 2024

(54) WIRELESS COMMUNICATION METHOD AND TERMINAL DEVICE

(71) Applicant: GUANGDONG OPPO MOBILE TELECOMMUNICATIONS CORP., LTD., Dongguan (CN)

(72) Inventors: Qianxi LU, Dongguan (CN); Bingxue LENG, Dongguan (CN); Boyuan ZHANG, Dongguan (CN); Shichang ZHANG, Dongguan (CN)

(73) Assignee: GUANGDONG OPPO MOBILE TELECOMMUNICATIONS CORP., LTD., Dongguan (CN)

(21) Appl. No.: 18/747,239

(22) Filed: Jun. 18, 2024

Related U.S. Application Data
(63) Continuation of application No. PCT/CN2021/139511, filed on Dec. 20, 2021.

(51) Int. Cl. H04W 72/02; H04W 72/0446; H04W 72/25; H04W 80/02

(52) U.S. Cl. CPC H04W 72/02; H04W 72/0446; H04W 72/25; H04W 80/02

(57) ABSTRACT

A wireless communication method and a terminal device are provided. The method includes: sending, by a first terminal, a first medium access control control element MAC CE to a second terminal, where the first MAC CE includes N pieces of resource combination information, the N pieces of resource combination information are used to assist the second terminal in performing resource selection, and N is a positive integer.

### CROSS-REFERENCE TO RELATED APPLICATIONS

This application is a continuation of International Application No. PCT/CN2021/139511, filed on Dec. 20, 2021, the disclosure of which is hereby incorporated by reference in its entirety.

### TECHNICAL FIELD

Embodiments of this application relate to the field of communications, and specifically, to a wireless communication method and a terminal device.

### BACKGROUND

In a new radio vehicle to everything (NR-V2X) system, two transmission modes are defined: a mode A and a mode B. Mode A: A transmission resource of a terminal is allocated by a base station, and the terminal sends data on a sidelink according to the resource allocated by the base station. Mode B: A terminal selects a resource from a resource pool to perform data transmission.

For the mode B, the terminal randomly selects a transmission resource in the resource pool, or selects a transmission resource according to a listening result. In this resource selection manner, interference between terminals may be avoided to an extent. However, other problems exist, such as a data transmission interference problem caused by a hidden node, a resource waste problem caused by half-duplex, and a power consumption problem caused by listening performed by the terminal. Therefore, resource selection auxiliary information is introduced. For example, a terminal A may send resource selection auxiliary information to a terminal B, so that the terminal B performs resource selection. In this case, how the terminal A sends the resource selection auxiliary information to the terminal B is an urgent problem to be resolved.

### SUMMARY

This application provides a wireless communication method and a terminal device. A first terminal may indicate resource selection auxiliary information to a second terminal by using a MAC CE, so that the second terminal may perform resource selection according to the resource selection auxiliary information, which is conducive to assisting the second terminal in selecting a proper resource, thereby improving performance of sidelink transmission.

According to a first aspect, a wireless communication method is provided, including: sending, by a first terminal, a first medium access control control element MAC CE to a second terminal, where the first MAC CE includes N pieces of resource combination information, the N pieces of resource combination information are used to assist the second terminal in performing resource selection, and the N is a positive integer.

According to a second aspect, a wireless communication method is provided, including: receiving, by a second terminal, a first medium access control control element MAC CE sent by a first terminal, where the first MAC CE includes N pieces of resource combination information, the N pieces of resource combination information are used to assist the second terminal in performing resource selection, and N is a positive integer.

According to a third aspect, a terminal device is provided, and is configured to execute the method according to the first aspect or implementations of the first aspect.

Specifically, the terminal device includes a functional module configured to execute the method according to the first aspect or implementations of the first aspect.

According to a fourth aspect, a terminal device is provided, and is configured to execute the method according to the second aspect or implementations of the second aspect.

Specifically, the terminal device includes a functional module configured to execute the method according to the second aspect or implementations of the second aspect.

According to a fifth aspect, a terminal device is provided, including a processor and a memory. The memory is configured to store a computer program, and the processor is configured to invoke and run the computer program stored in the memory to execute the method according to the first aspect or implementations of the first aspect.

According to a sixth aspect, a terminal device is provided, including a processor and a memory. The memory is configured to store a computer program, and the processor is configured to invoke and run the computer program stored in the memory to execute the method according to the second aspect or implementations of the second aspect.

According to a seventh aspect, a chip is provided, and is configured to implement the method according to any one of the first aspect and the second aspect or implementations of the first aspect and the second aspect.

Specifically, the chip includes a processor, configured to invoke a computer program from a memory and run the computer program, to cause a device on which the chip is installed to execute the method according to any one of the first aspect and the second aspect or implementations of the first aspect and the second aspect.

According to an eighth aspect, a computer-readable storage medium is provided, and is configured to store a computer program, where the computer program causes a computer to execute the method according to any one of the first aspect and the second aspect or implementations of the first aspect and the second aspect.

According to a ninth aspect, a computer program product is provided, including computer program instructions, where the computer program instructions cause a computer to execute the method according to any one of the first aspect and the second aspect or implementations of the first aspect and the second aspect.

According to a tenth aspect, a computer program is provided, and when the computer program runs on a computer, the computer executes the method according to any one of the first aspect and the second aspect or implementations of the first aspect and the second aspect.

By using the foregoing technical solutions, a first terminal may indicate resource selection auxiliary information to a second terminal by using a MAC CE, so that the second terminal may perform resource selection according to the resource selection auxiliary information, which is conducive to assisting the second terminal in selecting a proper resource, thereby improving performance of sidelink transmission.

### BRIEF DESCRIPTION OF DRAWINGS

FIG. 1 is a schematic diagram of a communications system architecture to which an embodiment of this application is applied.

FIG. 2 is a schematic diagram of another communications system architecture to which an embodiment of this application is applied.

FIG. 3 is a schematic diagram of a resource reservation manner according to this application.

FIG. 4 is a schematic diagram of interaction in a wireless communication method according to an embodiment of this application.

FIG. 5 is a diagram of a format of an information field of resource combination information according to an embodiment of this application.

FIG. 6 is a diagram of another format of an information field of resource combination information according to an embodiment of this application.

FIG. 7 is a diagram of still another format of an information field of resource combination information according to an embodiment of this application.

FIG. 8 is a diagram of yet another format of an information field of resource combination information according to an embodiment of this application.

FIG. 9 is a diagram of a format of a MAC CE according to an embodiment of this application.

FIG. 10 is a schematic block diagram of a terminal device according to an embodiment of this application.

FIG. 11 is a schematic block diagram of a network device according to an embodiment of this application.

FIG. 12 is a schematic block diagram of a communications device according to an embodiment of this application.

FIG. 13 is a schematic block diagram of a chip according to an embodiment of this application.

FIG. 14 is a schematic block diagram of a communications system according to an embodiment of this application.

### DESCRIPTION OF EMBODIMENTS

The following describes the technical solutions in embodiments of this application with reference to the accompanying drawings in embodiments of this application. Apparently, the described embodiments are some rather than all of embodiments of this application. For embodiments of this application, all other embodiments obtained by a person of ordinary skill in the art without creative efforts fall within the protection scope of this application.

The technical solutions in embodiments of this application may be applied to various communications systems, for example, a global system for mobile communications (GSM), a code division multiple access (CDMA) system, a wideband code division multiple access (WCDMA) system, general packet radio service (GPRS), a long-term evolution (LTE) system, an advanced long-term evolution (LTE-A) system, a new radio (NR) system, an evolved system of an NR system, an LTE-based access to unlicensed spectrum (LTE-U) system, an NR-based access to unlicensed spectrum (NR-U) system, a non-terrestrial networks (NTN) system, a universal mobile telecommunication system (UMTS), a wireless local area network (WLAN), wireless fidelity (WiFi), a fifth-generation (5G) system, or another communications system.

Generally, a quantity of connections supported by a conventional communications system is limited and is also easy to implement. However, with development of communication technologies, a mobile communications system not only supports conventional communication, but also supports, for example, device-to-device (D2D) communication, machine to machine (M2M) communication, machine type communication (MTC), vehicle to vehicle (V2V) communication, or vehicle to everything (V2X) communication. Embodiments of this application may also be applied to these communications systems.

Optionally, a communications system in embodiments of this application may be applied to a carrier aggregation (CA) scenario, a dual connectivity (DC) scenario, or a standalone (SA) networking scenario.

Optionally, the communications system in embodiments of this application may be applied to an unlicensed spectrum, and the unlicensed spectrum may also be considered as a shared spectrum. Alternatively, the communications system in embodiments of this application may be applied to a licensed spectrum, and the licensed spectrum may also be considered as a non-shared spectrum.

Embodiments of this application are described with reference to a network device and a terminal device. The terminal device may also be referred to as a user equipment (UE), an access terminal, a user unit, a user station, a mobile site, a mobile station, a remote station, a remote terminal, a mobile device, a user terminal, a terminal, a wireless communications device, a user agent, a user apparatus, or the like.

The terminal device may be a station ST) in a WLAN, may be a cellular phone, a cordless phone, a session initiation system (SIP) phone, a wireless local loop (WLL) station, a personal digital assistant (PDA) device, a handheld device with a wireless communication function, a computing device or another processing device connected to a wireless modem, a vehicle-mounted device, a wearable device, a terminal device in a next-generation communications system such as an NR network, or a terminal device in a future evolved public land mobile network (PLMN), or the like.

In embodiments of this application, the terminal device may be deployed on land, including being indoors or outdoors, may be handheld, wearable, or vehicle-mounted. The terminal device may be deployed on water (for example, on a ship), or may be deployed in the air (for example, on an airplane, an air balloon, or a satellite).

In embodiments of this application, the terminal device may be a mobile phone, a tablet computer (Pad), a computer with a wireless transceiver function, a virtual reality (VR) terminal device, an augmented reality (AR) terminal device, a wireless terminal device in industrial control, a wireless terminal device in self-driving, a wireless terminal device in remote medical, a wireless terminal device in smart grid, a wireless terminal device in transportation safety, a wireless terminal device in smart city, or a wireless terminal device in smart home, or the like.

By way of example rather than limitation, in embodiments of this application, the terminal device may alternatively be a wearable device. The wearable device may also be referred to as an intelligent wearable device, and is a general term for wearable devices such as glasses, gloves, watches, clothes, and shoes that are intelligently designed and developed based on daily wearing by using a wearable technology. The wearable device is a portable device that can be directly worn or integrated into clothes or accessories of a user. In addition to being a hardware device, the wearable device can also realize various functions through software support, data interaction, and cloud interaction. In a broad sense, wearable smart devices may include a full-featured and large-sized device that can provide full or partial functions without relying on a smart phone, for example, a smart watch or smart glasses, and devices that only focus on a specific type of application function and need to cooperate with another device such as a smart phone for use, for example, various smart bracelets and smart jewelries for physical sign monitoring.

In embodiments of this application, the network device may be a device configured to communicate with a mobile device. The network device may be an access point (AP) in a WLAN, may be a base transceiver station (BTS) in GSM or CDMA, may be a NodeB (NB) in WCDMA, or may be an evolutional Node B (eNB or eNodeB) in LTE, or a relay station or an access point, or a vehicle-mounted device, a wearable device, a network device or gNB in an NR network, or a network device in a future evolved PLMN, or a network device in an NTN, or the like.

By way of example rather than limitation, in embodiments of this application, the network device may have a mobility characteristic. For example, the network device may be a mobile device. Optionally, the network device may be a satellite or a balloon station. For example, the satellite may be a low earth orbit (LEO) satellite, a medium earth orbit (MEO) satellite, a geostationary earth orbit (GEO) satellite, a high elliptical orbit (HEO) satellite, or the like. Optionally, the network device may alternatively be a base station disposed in a location such as land or water.

In embodiments of this application, the network device may provide a service for a cell. The terminal device communicates with the network device by using a transmission resource (for example, a frequency domain resource or a spectrum resource) used by the cell. The cell may be a cell corresponding to the network device (for example, a base station). The cell may belong to a macro station or may belong to a base station corresponding to a small cell. The small cell herein may include a metro cell, a micro cell, a pico cell, a femto cell, or the like. These small cells have a characteristic of a small coverage range and low transmit power, and are applicable to providing a high-rate data transmission service.

It should be understood that the terms “system” and “network” may often be used interchangeably in this specification. In this specification, the term “and/or” is merely an association relationship that describes associated objects, and represents that there may be three relationships. For example, A and/or B may represent three cases: only A exists, both A and B exist, and only B exists. In addition, the character “/” in this specification generally indicates an “or” relationship between the associated objects.

The terms used in implementations of this application are only used to illustrate specific embodiments of this application, but are not intended to limit this application. The terms “first”, “second”, “third”, “fourth”, and the like in the specification, claims, and accompanying drawings of this application are used for distinguishing different objects from each other, rather than defining a specific order. In addition, the terms “include” and “have” and any variations thereof are intended to cover a non-exclusive inclusion.

It should be understood that, the “indication” mentioned in embodiments of this application may be a direct indication or an indirect indication, or indicate an association. For example, if A indicates B, it may mean that A directly indicates B, for example, B can be obtained from A. Alternatively, it may mean that A indicates B indirectly, for example, A indicates C, and B can be obtained from C. Alternatively, it may mean that there is an association between A and B.

In the description of embodiments of this application, the term “corresponding” may mean that there is a direct or indirect correspondence between two elements, or that there is an association between two elements, or that there is a relationship of “indicating” and “being indicated”, “configuring” and “being configured”, or the like.

In embodiments of this application, the “predefining” and “pre-configuration” can be implemented by pre-storing a corresponding code or table in a device (for example, including the terminal device and the network device) or in other manners that can be used for indicating related information, and a specific implementation thereof is not limited in this application. For example, pre-defining may refer to being defined in a protocol.

In embodiments of this application, the “protocol” may refer to a standard protocol in the communication field, which may include, for example, an LTE protocol, an NR protocol, and a related protocol applied to a future communications system. This is not limited in this application.

To facilitate understanding of the technical solutions in embodiments of this application, the following describes the technical solutions in this application in detail by using specific embodiments. The following related technologies, as optional solutions, may be randomly combined with the technical solutions of embodiments of this application, all of which fall within the protection scope of embodiments of this application. Embodiments of this application include at least a part of the following content.

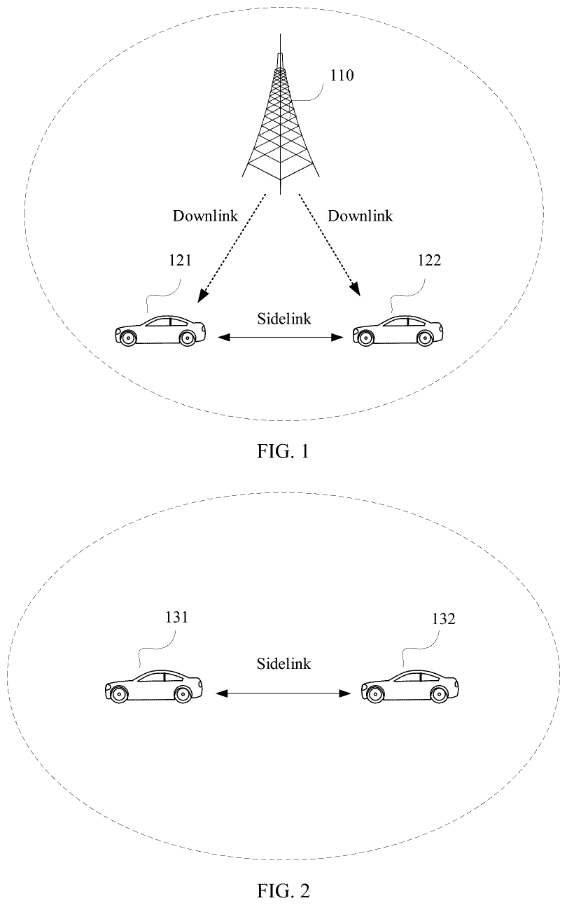

FIG. 1 is a schematic diagram of a communications system to which an embodiment of this application is applied. Transmission resources of vehicle-mounted terminals (a vehicle-mounted terminal 121 and a vehicle-mounted terminal 122) are allocated by a base station 110, and the vehicle-mounted terminals each send data on a sidelink based on the resources allocated by the base station 110. Specifically, the base station 110 may allocate, to a terminal, a resource for single transmission, or may allocate, to a terminal, a resource for semi-static transmission.

FIG. 2 is a schematic diagram of another communications system to which an embodiment of this application is applied. Vehicle-mounted terminals (a vehicle-mounted terminal 131 and a vehicle-mounted terminal 132) independently select transmission resources from resources on a sidelink to perform data transmission. Optionally, the vehicle-mounted terminals may randomly select transmission resources, or select transmission resources in a listening manner.

Device-to-device communication is a sidelink (SL) transmission technology based on terminal-to-terminal (D2D). Different from a conventional cellular system in which communication data is received or sent by using a base station, in a vehicle to everything system, terminal-to-terminal direct communication is adopted, which has higher spectral efficiency and a lower transmission latency. Two transmission modes are defined in 3GPP, and are respectively denoted as a mode (sidelink resource allocation mode A) and a second mode (sidelink resource allocation mode B).

Mode A: A transmission resource of a terminal is allocated by a base station, and the terminal sends data on a sidelink based on the resource allocated by the base station. The base station may allocate, to the terminal, a resource for single transmission, or may allocate, to the terminal, a resource for semi-static transmission.

Mode B: A terminal selects a resource from a resource pool to perform data transmission.

A proximity-based service (ProSe) relates to device-to-device communication, and is mainly for a public security service. In ProSe, a position of a resource pool in time domain is configured, for example, the resource pool is discontinuous in time domain, so that a UE discontinuously sends or receives data on a sidelink. In this way, a power saving effect is achieved.

A vehicle to everything system mainly studies a scenario of communication between vehicles, and is mainly for services of communication between vehicles or between a vehicle and a person that move at a relatively high speed. In V2X, because a vehicle-mounted system is constantly powered, power efficiency is not a major problem, and a latency of data transmission is a major problem. Therefore, a terminal device is required to perform continuous sending and receiving in a system design.

In a wearable device (FeD2D) scenario, a scenario in which a wearable device accesses a network by using a mobile phone is studied, and is mainly for a scenario of a low moving speed and low power access.

In FeD2D, a base station may configure a discontinuous reception (DRX) parameter of a remote terminal by using a relay terminal.

In new radio-vehicle to everything (NR-V2X), autonomous driving is supported. Therefore, higher requirements are imposed on data interaction between vehicles, such as a higher throughput, a lower latency, higher reliability, larger coverage, and more flexible resource allocation.

In an LTE-V2X system, broadcast transmission is supported. In an NR-V2X system, unicast transmission and multicast transmission are introduced.

Similar to the LTE V2X system, the NR V2X system may also define the foregoing two resource authorization modes: the mode A and the mode B. Resource acquisition is indicated through authorization of a sidelink, that is, the sidelink authorizes to indicate a time-frequency position of a corresponding physical sidelink control channel (PSCCH) resource and a corresponding physical sidelink shared channel (PSSCH) resource.

In addition to hybrid automatic repeat request (HARQ) retransmission independently initiated by a UE without feedback, feedback-based HARQ retransmission is introduced into NR V2X, which is not limited to unicast communication and also includes multicast communication.

In NR V2X, because a vehicle-mounted system is constantly powered, power efficiency is not a major problem, and a latency of data transmission is a major problem. Therefore, a terminal device is required to perform continuous sending and receiving in a system design.

To better understand embodiments of this application, resource reservation related to this application is described.

In an NR V2X system, in the foregoing mode B, a terminal device selects a resource to send data. In this case, resource reservation is a prerequisite for the terminal device to perform resource selection.

Resource reservation means that the terminal reserves a time-frequency resource that has been selected in first sidelink control information carried in a PSCCH. In the NR V2X system, both resource reservation in a transport block (TB) and resource reservation between TBs are supported.

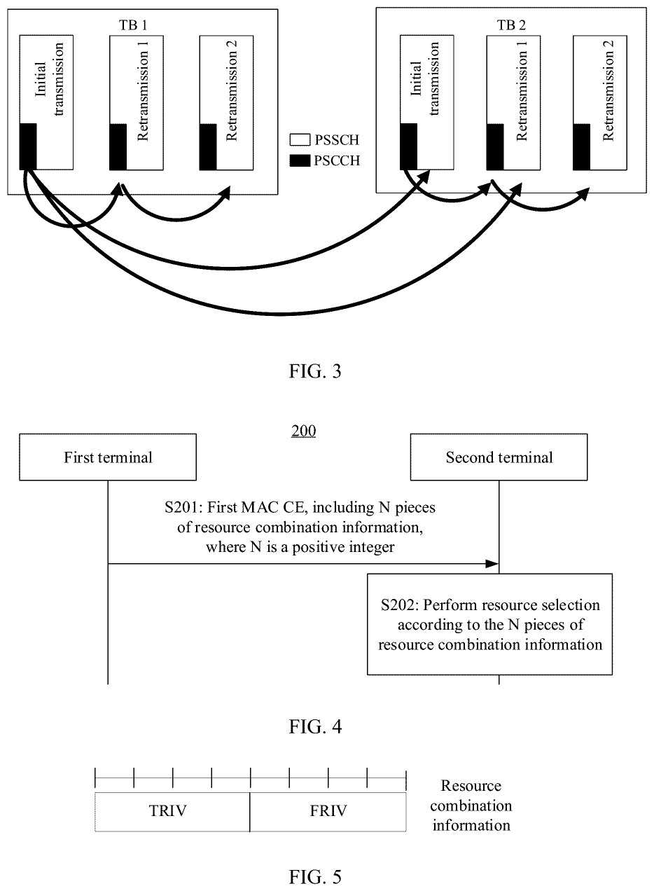

As shown in FIG. 3, a terminal device sends first sidelink control information, and indicates, by using a time domain resource assignment field and a frequency domain resource assignment field in the first sidelink control information, N time-frequency resources (including a time-frequency resource used for current transmission) used for transmission of a current TB.

For example, for a TB 1 in FIG. 3, the terminal device sends the first sidelink control information in a PSCCH while sending initial transmission data in the PSSCH, and indicates, by using the foregoing two fields, positions of time-frequency resources (that is, in this case, N=2) used for initial transmission and retransmission 1 of the TB 1, that is, a time-frequency resource is reserved for the retransmission 1. In addition, the time-frequency resources used for the initial transmission and the retransmission 1 are distributed in 32 timeslots in time domain. Similarly, in FIG. 3, for the TB 1, the terminal device indicates, by using the first sidelink control information sent in the PSCCH of the retransmission 1, time-frequency resources used for the retransmission 1 and retransmission 2, and the time-frequency resources used for the retransmission 1 and the retransmission 2 are distributed in 32 timeslots in time domain.

In some scenarios, the terminal device may further perform resource reservation between TBs by using a resource reservation period field while sending the first sidelink control information. For example, in FIG. 3, when sending the first sidelink control information for the initial transmission of the TB 1, the terminal device indicates positions of time-frequency resources used for the initial transmission and the retransmission 1 of the TB 1 by using a “Time resource assignment” field and a “Frequency domain resource assignment” field, which are denoted as {(t1,f1),(t2,f2)}, where t1 and t2 represent time domain positions of resources used for the initial transmission and the retransmission 1 of the TB 1, and f1 and f2 represent corresponding frequency domain positions. If a value of the “Resource reservation period” field in the first sidelink control information is 100 milliseconds, the first sidelink control information indicates time-frequency resources {(t1+100,f1),(t2+100,f2)}. The two resources are used for initial transmission and retransmission 1 of a TB 2. Similarly, time-frequency resources used for the retransmission 1 and retransmission 2 of the TB 2 may also be reserved, by using the “Resource reservation period” field, in first sidelink control information sent in the retransmission 1 of the TB 1.

Optionally, it may be configured through network configuration or pre-configuration that resource reservation between TBs is activated or deactivated in a unit of a resource pool. For example, when resource reservation between TBs is deactivated, the first sidelink control information does not include the “Resource reservation period” field. Generally, before resource reselection is triggered, the value of the “Resource reservation period” field used by the terminal device, that is, a resource reservation period, does not change. Each time the terminal device sends the first sidelink control information, the terminal device reserves, by using the “Resource reservation period” field in the first sidelink control information, a resource of a next period, which is used for transmission of another TB, so as to achieve periodic semi-persistent transmission.

For the mode B, the terminal device (for example, a UE-B) obtains a resource only through listening. In this resource selection manner, interference between terminals may be avoided to an extent, but other problems exist, such as a data transmission interference problem caused by a hidden node, a resource waste problem caused by half-duplex, and a power consumption problem caused by listening performed by the terminal. Resource selection auxiliary information is further introduced. For example, a terminal device (for example, a UE-A) may send resource selection auxiliary information to another terminal device (for example, the UE-B), to help the UE-B perform optimized resource selection. Therefore, how to send the resource selection auxiliary information is an urgent problem for a transmit end of the resource selection auxiliary information.

To facilitate understanding of the technical solutions in embodiments of this application, the following describes the technical solutions in this application in detail by using specific embodiments. The foregoing related technologies, as optional solutions, may be randomly combined with the technical solutions of embodiments of this application, all of which fall within the protection scope of embodiments of this application. Embodiments of this application include at least a part of the following content.

FIG. 4 is a schematic diagram of interaction in a wireless communication method 200 according to an embodiment of this application. As shown in FIG. 4, the method 200 includes at least a part of the following content:

S201: A first terminal sends a first medium access control control element (MAC CE) to a second terminal.

Correspondingly, the second terminal receives the first MAC CE from the first terminal.

The first MAC CE includes N pieces of resource combination information, the N pieces of resource combination information are used to assist the second terminal in performing resource selection, and N is a positive integer.

In some embodiments, the first terminal is referred to as a resource coordination terminal.

In some embodiments, the N pieces of resource combination information may be considered as resource selection auxiliary information.

In some embodiments, the resource combination information may be used to determine at least one resource, for example, may include but is not limited to a time domain resource and/or a frequency domain resource. Optionally, the at least one resource may be periodic, or may be aperiodic.

In some embodiments, the N pieces of resource combination information may be determined by the first terminal according to a resource listening result.

In some embodiments, a resource indicated by the resource combination information may be a preferred resource, or in other words, a resource that the first terminal expects the second terminal to select, or an available resource, or a resource suitable for use by the second terminal.

In some other embodiments, the resource indicated by the resource combination information may also be a non-preferred resource, or in other words, a resource that the first terminal does not expect the second terminal to select, or an unavailable resource, or a resource that is not suitable for use by the second terminal.

In some embodiments of this application, the method 200 further includes:

S202: The second terminal performs resource selection according to the N pieces of resource combination information.

For example, the second terminal preferentially selects a preferred resource from resources indicated by the N pieces of resource combination information, and excludes a non-preferred resource.

Therefore, in embodiments of this application, the first terminal uses the MAC CE to carry the resource combination information, so that the second terminal performs resource selection, which optimizes resource selection on the second terminal side, thereby improving performance of sidelink transmission.

In some embodiments of this application, a length of the first MAC CE is fixed.

For example, the length of the first MAC CE is determined according to a size of Nₘₐₓ pieces of resource combination information.

Nₘₐₓ is a maximum quantity of pieces of resource combination information, or in other words, a maximum quantity of resource combination information that are allowed to be indicated.

Optionally, in a case that the length of the first MAC CE is fixed and a quantity of pieces of resource combination information that needs to be sent by the first terminal is less than Nₘₐₓ, 0s or invalid bits may be filled in the remaining bits in the first MAC CE.

Optionally, in a case that the length of the first MAC CE is fixed and a quantity of pieces of resource combination information that needs to be sent by the first terminal is greater than Nₘₐₓ, some pieces of resource combination information may be dropped, and only Nₘₐₓ pieces of resource combination information are reported.

In some other embodiments of this application, the length of the first MAC CE is variable.

Optionally, the length of the first MAC CE may be determined according to a size of resource combination information that is actually carried.

For example, the length of the first MAC CE is determined according to a size of the N pieces of resource combination information, where N is less than or equal to Nₘₐₓ, and Nₘₐₓ is a maximum quantity of pieces of resource combination information.

Optionally, Nₘₐₓ may be predefined or configured by a network device. For example, the network device may indicate Nₘₐₓ to the terminal device by using a system message, dedicated signalling, or the like.

Optionally, the dedicated signalling may include but is not limited to radio resource control (RRC) signalling or MAC signalling.

In some embodiments, Nₘₐₓ may be configured for a granularity of a resource pool.

For example, a maximum quantity Nₘₐₓ of pieces of resource combination information corresponding to each resource pool is predefined, or the network device configures the corresponding maximum quantity Nₘₐₓ of pieces of resource combination information for each resource pool. In this way, when sending resource combination information, the first terminal may determine, according to a resource pool to which the resource combination information belongs, a maximum quantity Nₘₐₓ of pieces of resource combination information that may be sent.

In some embodiments of this application, the N pieces of resource combination information are successively included in the first MAC CE in a preset order.

For example, an order of the N pieces of resource combination information in the first MAC CE may be determined according to signal quality on resources indicated by the N pieces of resource combination information.

As an example, the N pieces of resource combination information are successively included in the first MAC CE in ascending order of signal quality. Low signal quality may be considered as a low level of interference on the resource, that is, the N pieces of resource combination information may be successively included in the first MAC CE in ascending order of interference. In this way, when performing resource selection, the second terminal that receives the first MAC CE may preferentially select resource combination information that is ranked high, which is conducive to selecting a resource combination with relatively low interference, thereby improving performance of sidelink transmission.

Optionally, the signal quality may be represented by but is not limited to the following indicators:
reference signal receiving power (RSRP), reference signal receiving quality (RSRQ), signal to interference plus noise ratio (SINR), and received signal strength indication (RSSI).

It should be understood that in the first MAC CE, information fields corresponding to different pieces of resource combination information may be the same or may be different in format, which is not limited in this application.

In some embodiments of this application, the resource combination information includes first time resource indicator value (TRIV) information and first frequency resource indicator value (FRIV) information.

That is, the resource combination information may be indicated by using time domain resource indication information (for example, first TRIV information) and frequency domain resource indication information (for example, first FRIV information). In other words, at least one time-frequency resource may be determined according to the resource combination information.

In some embodiments of this application, the N pieces of resource combination information may be used to determine a retransmission resource used for sidelink transmission. That is, the first terminal may indicate the N pieces of resource combination information to the second terminal, so that the second terminal selects a retransmission resource used for sidelink transmission.

In some embodiments of this application, a length of an information field occupied by the first TRIV information is fixed.

For example, a time domain resource indicated by the first TRIV information is distributed in W time domain units (for example, timeslots), and the first TRIV information is used to indicate one time domain unit among the W time domain units. Therefore, the length of the information field occupied by the first TRIV information may be determined according to W.

As an example, if W is equal to 32, the length of information occupied by the first TRIV information may be fixed to 5 bits or 8 bits.

In some other embodiments of this application, the length of the information field occupied by the first TRIV information is variable.

Optionally, that the length of the information field occupied by the first TRIV information is variable includes:
the length of the information field occupied by the first TRIV information is determined according to configuration information.

As an example but not a limitation, the configuration information may include but is not limited to at least one of pre-configuration information, a system message, and dedicated signalling. That is, the length of the information field occupied by the first TRIV information may be predefined or configured by the network device, for example, configured by using a system message or dedicated signalling. Optionally, the dedicated signalling may include but is not limited to RRC signalling or MAC signalling.

In some embodiments, the configuration information may be configured for a granularity of a resource pool. For example, for different resource pools, corresponding lengths of an information field occupied by first TRIV information are configured respectively.

In some embodiments, the length of the information field occupied by the first TRIV information may be determined according to a higher layer parameter.

For example, in a case that a higher layer parameter, that is, a maximum quantity per reserve on a sidelink (sl-MaxNumPerReserve), is set to 2, a length of an information field occupied by the first TRIV information is 5 bits. In a case that the higher layer parameter sl-MaxNumPerReserve is set to 3, the length of the information field occupied by the first TRIV information is 9 bits.

In some embodiments of this application, a length of an information field occupied by the first FRIV information is fixed.

For example, if a frequency domain resource indicated by the first FRIV information is distributed in X frequency domain units (for example, sub-channels), and the first FRIV information is used to indicate one frequency domain unit among the X frequency domain units, the length of the information field occupied by the first FRIV information may be determined according to X.

As an example, if X is equal to 32, the length of information occupied by the first FRIV information may be fixed to 5 bits or 8 bits.

In some other embodiments of this application, the length of the information field occupied by the first FRIV information is variable.

Optionally, that the length of the information field occupied by the first FRIV information is variable includes:
the length of the information field occupied by the first FRIV information is determined according to configuration information.

As an example but not a limitation, the configuration information may include but is not limited to at least one of pre-configuration information, a system message, and dedicated signalling. That is, the length of the information field occupied by the first FRIV information may be predefined or configured by the network device, for example, configured by using a system message or dedicated signalling. Optionally, the dedicated signalling may include but is not limited to RRC signalling or MAC signalling.

In some embodiments, the configuration information may be configured for a granularity of a resource pool. For example, for different resource pools, corresponding lengths of an information field occupied by first FRIV information are configured respectively.

In some embodiments, the length of the information field occupied by the first FRIV information may be determined according to a higher layer parameter (for example, sl-MaxNumPerReserve).

For example, in a case that the higher layer parameter sl-MaxNumPerReserve is set to 2, a length of an information field occupied by the first FRIV information is a first length. In a case that the higher layer parameter sl-MaxNumPerReserve is set to 3, the length of the information field occupied by the first FRIV information is a second length. The first length is different from the second length.

Optionally, the first length may be

$$⌈ {log}_{2} \frac{{N}_{subChnnel}^{SL} ( {N}_{subChnnel}^{SL} + 1 )}{2} ⌉ bits ,$$

and the second length may be

$$⌈ {log}_{2} \frac{{N}_{subChannel}^{SL} ( {N}_{subChannel}^{SL} + 1 ) ( 2 {N}_{subChannel}^{SL} + 1 )}{6} ⌉ bits ,$$

where ┌ ┐ indicates rounding up, and N_{subChannel}^{SL} indicates a quantity of sub-channels of a sidelink.

FIG. 5 is a schematic diagram of a format of an information field of resource combination information according to an embodiment of this application. As shown in FIG. 5, the information field of the resource combination information may include only information fields corresponding to the TRIV information and the FRIV information.

It should be understood that lengths of the information fields occupied by the TRIV information and the FRIV information that are shown in FIG. 5 are merely examples. In another embodiment, the information fields occupied by the TRIV information and the FRIV information may have other lengths. In addition, when format setting is performed, an operation such as byte alignment or reservation (R) bit padding may be further performed, which is not limited in this application.

In some embodiments of this application, the resource combination information further includes resource reservation period information.

Optionally, the resource reservation period information may be period information of a time domain resource indicated by the first TRIV information. Therefore, a semi-static resource may be determined according to the first TRIV information and the resource reservation period information.

In some embodiments of this application, a length of an information field occupied by the resource reservation period information is fixed.

In some embodiments, a resource reservation period indicated by the resource reservation period information belongs to a resource reservation period list, and the length of the information field occupied by the resource reservation period information may be determined according to a quantity of resource reservation periods included in the resource reservation period list.

For example, the resource reservation period list includes 16 resource reservation periods, and the length of the information field occupied by the resource reservation period information may be fixed to 4 bits or 8 bits.

In some embodiments, the resource reservation period list is configured for a granularity of a resource pool. For example, for different resource pools, corresponding resource reservation period lists may be configured respectively.

In some other embodiments of this application, the length of the information field occupied by the resource reservation period information is variable.

For example, the length of the information field occupied by the resource reservation period information is determined according to configuration information.

As an example but not a limitation, the configuration information may include but is not limited to at least one of pre-configuration information, a system message, and dedicated signalling. Optionally, the dedicated signalling may include but is not limited to RRC signalling or MAC signalling.

In some embodiments, the configuration information may be configured for a granularity of a resource pool. For example, for different resource pools, corresponding lengths of an information field occupied by resource reservation period information are configured respectively.

In some embodiments, the length of the information field occupied by the resource reservation period information may be determined according to a higher layer parameter.

For example, the length of the information field occupied by the resource reservation period information may be determined according to a higher layer parameter, that is, a multi-reserve resource on a sidelink (sl-MultiReserveResource).

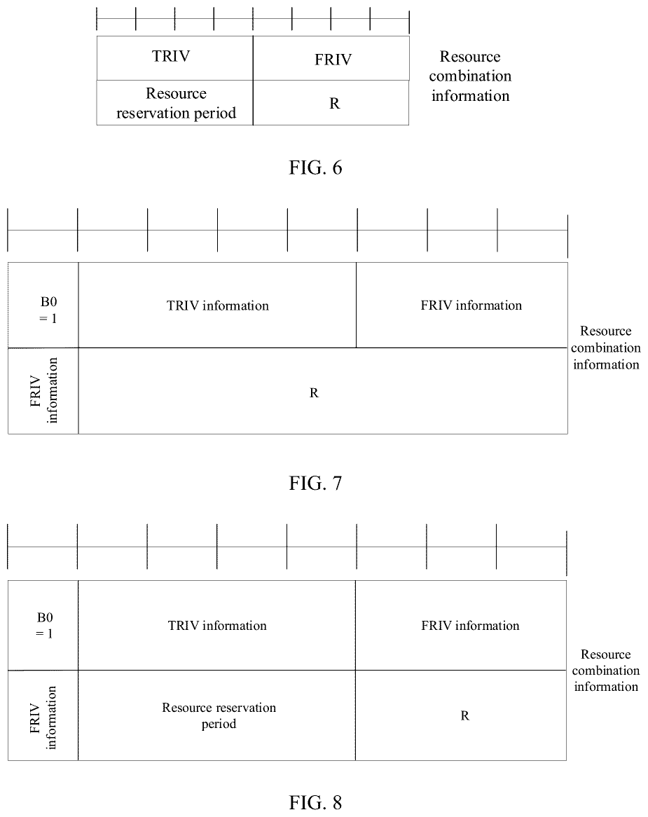

FIG. 6 is a schematic diagram of another format of an information field of resource combination information according to an embodiment of this application.

As shown in FIG. 6, the information field of the resource combination information may include information fields respectively corresponding to TRIV information, FRIV information, and resource reservation period information. Optionally, a reservation (R) field may further be included.

It should be understood that lengths of the information fields occupied by the TRIV information, the FRIV information, and the resource reservation period information that are shown in FIG. 6 are merely examples. In another embodiment, the information fields occupied by the TRIV information, the FRIV information, and the resource reservation period information may have other lengths. In addition, when format setting is performed, an operation such as byte alignment or reservation bit padding may be further performed, which is not limited in this application.

In some embodiments of this application, the first MAC CE includes first indication information, and the first indication information is used to indicate whether all pieces of resource combination information in the first MAC CE each include resource reservation period information.

In this case, optionally, an information field of the first indication information may not be included in an information field corresponding to each piece of resource combination information. That is, the information field of the first indication information and the information field of the resource combination information may be independent information fields.

In some other embodiments of this application, the first MAC CE includes second indication information corresponding to each piece of resource combination information among the N pieces of resource combination information, and the second indication information corresponding to each piece of resource combination information is used to indicate whether the resource combination information includes resource reservation period information.

Optionally, the second indication information may be in one bit. If a value of the one bit is 1, it indicates that the resource combination information includes resource reservation period information. If the value of the one bit is 0, it indicates that the resource combination information does not include resource reservation period information.

In some implementations, the second indication information corresponding to each piece of resource combination information is included in the information field of the piece of resource combination information.

FIG. 7 is a schematic diagram of still another format of an information field of resource combination information according to an embodiment of this application.

As shown in FIG. 7, the resource combination information may include second indication information (carried in B0). A value of the second indication information is 0, which indicates that the resource combination information does not include resource reservation period information, and the information field corresponding to the resource combination information includes information fields corresponding to TRIV information and FRIV information, and does not include an information field corresponding to resource reservation period information.

It should be understood that lengths of the information fields occupied by the TRIV information and the FRIV information that are shown in FIG. 7 are merely examples. In another embodiment, the information fields occupied by the TRIV information and the FRIV information may have other lengths. In addition, when format setting is performed, an operation such as byte alignment or reservation bit padding may be further performed, which is not limited in this application.

FIG. 8 is a schematic diagram of yet another format of an information field of resource combination information according to an embodiment of this application.

As shown in FIG. 8, the resource combination information may include second indication information (carried in B0). A value of the second indication information is 1, which indicates that the resource combination information includes resource reservation period information, and the information field corresponding to the resource combination information further includes information fields respectively corresponding to TRIV information, FRIV information, and the resource reservation period information.

It should be understood that lengths of the information fields occupied by the TRIV information, the FRIV information, and the resource reservation period information that are shown in FIG. 8 are merely examples. In another embodiment, the information fields occupied by the TRIV information, the FRIV information, and the resource reservation period information may have other lengths. In addition, when format setting is performed, an operation such as byte alignment or reservation bit padding may be further performed, which is not limited in this application.

In some other implementations, the second indication information corresponding to each piece of resource combination information may not be included in an information field corresponding to each piece of resource combination information, and the second indication information corresponding to the piece of resource combination information may be independently set in the first MAC CE in a bitmap manner.

For example, the first MAC CE includes a first bitmap, the first bitmap includes N bits, each bit corresponds to one piece of resource combination information, and a value of each bit is used to indicate whether resource combination information corresponding to the bit includes resource reservation period information.

Optionally, in the first MAC CE, an information field corresponding to the first bitmap may be set before an information field corresponding to the N pieces of resource combination information.

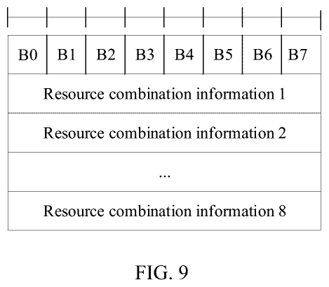

FIG. 9 is a schematic diagram of a format of a first MAC CE in an example in which N is equal to 8. As shown in FIG. 9, the first MAC CE may include a first bitmap (B0 to B7) and eight pieces of resource combination information (resource combination information 1 to resource combination information 8). Each bit corresponds to one piece of resource combination information, for example, Bi corresponds to resource combination information i+1, where i=0, 1, 2, . . . , 7. A value of each bit is used to indicate whether the resource combination information corresponding to the bit includes resource reservation period information.

For example, in a case that a value of Bi is 1, an information field corresponding to the resource combination information i+1 includes information fields respectively corresponding to first TRIV information, first FRIV information, and resource reservation period information. In a case that the value of Bi is 0, the information field corresponding to the resource combination information i+1 includes information fields corresponding to first TRIV information and first FRIV information.

In some embodiments of this application, the first terminal may not send, to the second terminal, first resource allocation information corresponding to the N pieces of resource combination information. In this case, the first resource allocation corresponding to the N pieces of resource combination information may be determined according to a time-frequency resource for sending the first MAC CE.

Optionally, the first resource allocation information may be used to determine an initial transmission resource used for sidelink transmission. That is, the first terminal may indicate the first resource allocation information to the second terminal, so that the second terminal selects the initial transmission resource used for sidelink transmission.

In some other embodiments of this application, the first MA CE includes at least one piece of first resource allocation information.

That is, the first terminal may indicate, to the second terminal, both the initial transmission resource and a retransmission resource that are used for sidelink transmission.

With reference to a manner 1 and a manner 2, the following describes a manner in which the first resource allocation information is carried in the first MAC CE.

Manner 1: The first resource allocation information is carried in an independent information field.

That is, in the manner 1, the first resource allocation information and the resource combination information are used as independent information.

In some embodiments, the first MAC CE includes M pieces of first resource allocation information, the M pieces of first resource allocation information correspond to the N pieces of resource combination information, M is a positive integer, and M is less than or equal to N.

For example, M=1, that is, the first MAC CE includes one piece of first resource allocation information, and the one piece of first resource allocation corresponds to the N pieces of resource combination information. That is, retransmission resources indicated by the N pieces of resource combination information correspond to a same initial transmission resource.

For another example, M=N, that is, the first MAC CE includes N pieces of first resource allocation information, and each piece of first resource allocation corresponds to one piece of resource combination information among the N pieces of resource combination information. That is, a retransmission resource indicated by each piece of resource combination information corresponds to an independent initial transmission resource.

For another example, 1<M<N. In this case, some pieces of resource combination information may correspond to a same piece of first resource allocation information, and the other pieces of resource combination information respectively correspond to independent pieces of first resource allocation information. That is, retransmission resources indicated by some pieces of resource combination information among the N pieces of resource combination information correspond to independent initial transmission resources, and the other pieces of resource combination information correspond to a same initial transmission resource.

In some embodiments, the first resource allocation information may be designed in a format similar to that of the foregoing resource allocation information.

For example, the first resource allocation information includes second TRIV information and second FRIV information.

Optionally, the second TRIV information may be used to indicate a time domain resource used for retransmission, and the second FRIV information may be used to indicate a frequency domain resource used for retransmission.

For another example, the first resource allocation includes second TRIV information, second FRIV information, and resource reservation period information.

Optionally, the second TRIV information may be used to indicate a time domain resource used for retransmission, the second FRIV information may be used to indicate a frequency domain resource used for retransmission, and the resource reservation period information may be used to determine a period of the time domain resource.

In some embodiments, a length of an information field occupied by the second TRIV information may be fixed or may be variable. For a specific implementation, refer to a related design of the length of the information field occupied by the first TRIV information. For brevity, details are not described herein again.

In some embodiments, a length of an information field occupied by the second FRIV information may be fixed or may be variable. For a specific implementation, refer to a related design of the length of the information field occupied by the first FRIV information. For brevity, details are not described herein again.

In some embodiments, a length of an information field occupied by the resource reservation period information in the first resource allocation may be fixed or may be variable. For a specific implementation, refer to a related design of the length of the information field occupied by the resource reservation period information in the foregoing embodiments. For brevity, details are not described herein again.

Manner 2: The first resource allocation information is used as a part of the resource combination information.

For example, the first resource allocation information and the other resource combination information are carried in a same information field.

In embodiments of this application, for ease of distinction and description, the other information except the first resource allocation information in the resource combination information is denoted as second resource allocation information. A resource indicated by the first resource allocation information is earlier than a resource indicated by the second resource allocation information.

In some embodiments, the first resource allocation information may be used to determine an initial transmission resource used for sidelink transmission, and the second resource allocation information may be used to determine a retransmission resource used for sidelink transmission.

In some embodiments, a format design of the second resource allocation information may correspond to the format design of the resource combination information in the foregoing embodiments. For example, the second resource allocation information includes first TRIV information and first FRIV information, or the second resource allocation information includes first TRIV information, first FRIV information, and resource reservation period information. Optionally, the second resource allocation information further includes the foregoing first indication information or the foregoing second indication information.

Manner 2-1: A part of the information field of the second resource allocation information is reused as an information field of the first resource allocation.

For example, an information field corresponding to the first TRIV information, the second FRIV information, or the resource reservation period information in the second resource allocation information is reused.

In some embodiments, the first resource allocation information includes first time offset information, and the first time offset information is a time offset relative to a time domain resource indicated by the first TRIV information. In this case, a frequency domain resource indicated by the first FRIV information of the second resource allocation information may be reused as frequency domain resource information corresponding to the first resource allocation information, and/or, period information indicated by the resource reservation period information of the second resource allocation information may be reused as resource period information corresponding to the first resource allocation information.

In some other embodiments, the first resource allocation information includes third TRIV information. In this case, a frequency domain resource indicated by the first FRIV information of the second resource allocation information may be reused as frequency domain resource information corresponding to the first resource allocation information, and/or, period information indicated by the resource reservation period information of the second resource allocation information may be resued as resource period information corresponding to the first resource allocation information.

In some other embodiments, the first resource allocation information includes third FRIV information. In this case, period information indicated by the resource reservation period information of the second resource allocation information may be reused as the resource period information corresponding to the first resource allocation information.

In some embodiments, a length of an information field occupied by the third TRIV information may be fixed or may be variable. For a specific implementation, refer to a related design of the length of the information field occupied by the first TRIV information. For brevity, details are not described herein again.

In some embodiments, a length of an information field occupied by the third FRIV information may be fixed or may be variable. For a specific implementation, refer to a related design of the length of the information field occupied by the first FRIV information. For brevity, details are not described herein again.

Manner 2-2: An information field of the first resource allocation information is independently designed.

In some embodiments, the first resource allocation information may be designed in a format similar to that of the second resource allocation information.

For example, the first resource allocation information includes fourth TRIV information and fourth FRIV information.

Optionally, the fourth TRIV information may be used to indicate a time domain resource used for retransmission, and the fourth FRIV information may be used to indicate a frequency domain resource used for retransmission.

For another example, the first resource allocation information includes fourth TRIV information, fourth FRIV information, and resource reservation period information.

Optionally, the fourth TRIV information may be used to indicate a time domain resource used for retransmission, the fourth FRIV information may be used to indicate a frequency domain resource used for retransmission, and the resource reservation period information may be used to determine a period of the time domain resource.

In some embodiments, a length of an information field occupied by the fourth TRIV information may be fixed or may be variable. For a specific implementation, refer to a related design of the length of the information field occupied by the first TRIV information. For brevity, details are not described herein again.

In some embodiments, a length of an information field occupied by the fourth FRIV information may be fixed or may be variable. For a specific implementation, refer to a related design of the length of the information field occupied by the first FRIV information. For brevity, details are not described herein again.

In some embodiments, a length of an information field occupied by the resource reservation period information in the first resource allocation information may be fixed or may be variable. For a specific implementation, refer to a related design of the length of the information field occupied by the resource reservation period information in the foregoing embodiments. For brevity, details are not described herein again.

In some embodiments of this application, a manner in which the first resource allocation information is carried in the first MAC CE is determined by using configuration information.

Optionally, the configuration information includes at least one of the following: pre-configuration information, a system message, or dedicated signalling.

Optionally, the dedicated signalling may include but is not limited to RRC signalling or MAC signalling.

That is, the manner in which the first resource allocation information is carried in the MAC CE may be predefined, or a network device may configure the manner in which the first resource allocation information is carried in the MAC CE.

In some embodiments, the configuration information is configured for a granularity of a resource pool.

For example, manners in which the first resource allocation information is carried in the MAC CE may be predefined respectively for different resource pools, or the network device configures manners in which the first resource allocation information is carried in the MAC CE respectively for different resource pools.

In some embodiments of this application, the first MAC CE further includes third indication information, and the third indication information is used to indicate that a resource indicated by the N pieces of resource combination information is a preferred resource or a non-preferred resource.

In this case, an information field of the third indication information may not be included in an information field corresponding to each piece of resource combination information. That is, information fields corresponding to the third indication information and the resource combination information may be independent information fields.

In some other embodiments of this application, the first MAC CE includes fourth indication information corresponding to each piece of resource combination information among the N pieces of resource combination information, and the fourth indication information corresponding to each piece of resource combination information is used to indicate that a resource indicated by the piece of resource combination information is a preferred resource or a non-preferred resource.

Optionally, the fourth indication information may be in one bit. If a value of the one bit is 1, it indicates that a resource indicated by the resource combination information is a preferred resource. If the value of the one bit is 0, it indicates that the resource indicated by the resource combination information is not a preferred resource, or is a non-preferred resource.

In some implementations, the fourth indication information corresponding to each piece of resource combination information may be included in the information field corresponding to the piece of resource combination information.

In some other implementations, the fourth indication information corresponding to each piece of resource combination information may not be included in the information field corresponding to the piece of resource combination information, and the fourth indication information corresponding to each piece of resource combination information may be independently set in the first MAC CE in a bitmap manner.

For example, the first MAC CE includes a second bitmap, the second bitmap includes N bits, each bit corresponds to one piece of resource combination information, and a value of each bit is used to indicate whether a resource indicated by the resource combination information corresponding to the bit is a preferred resource.

Optionally, in the first MAC CE, an information field corresponding to the second bitmap may be set before an information field corresponding to the N pieces of resource combination information.

In some other embodiments of this application, that resources indicated by the N pieces of resource combination information are preferred resources or non-preferred resources is determined according to configuration information. Optionally, the configuration information includes at least of the following: pre-configuration information, a system message, or dedicated signalling. Optionally, the dedicated signalling may include but is not limited to RRC signalling or MAC signalling.

In some embodiments, the configuration information is configured for a granularity of a resource pool. For example, reporting of a preferred resource or a non-preferred resource may be predefined for different resource pools, or a network device configures indication of a referred resource or a non-preferred resource for different resource pools.

In some embodiments of this application, the first MAC CE further includes fifth indication information, and the fifth indication information is used to indicate a trigger condition of generating the resource combination information or the first MAC CE.

That is, the first MAC CE may include a trigger condition of generating the first MAC CE, or may include a trigger condition of generating the resource combination information in the first MAC CE.

In some embodiments, the fifth indication information may be at a granularity of a MAC CE. Optionally, in this case, an information field of the fifth indication information and an information field of the resource combination information may be independent information fields.

In some embodiments, the fifth indication information may be at a granularity of resource combination information. Optionally, in this case, the fifth indication information may be included in an information field of resource combination information.

In some embodiments, a length of the information field occupied by the fifth indication information may be determined according to a type of the trigger condition. For example, if a maximum of three trigger conditions are indicated, the fifth indication information is of at least 2 bits.

In some embodiments, the fifth indication information is used to indicate that generation of the resource combination information or the first MAC CE is triggered based on a request from the second terminal.

For example, the first terminal may receive a request message from the second terminal, where the request message is used to request the first terminal to send resource combination information to the second terminal, so that the second terminal performs resource selection. In this case, the first terminal may generate the first MAC CE or the resource combination information.

In some embodiments, the request message is a physical sidelink control channel, for example, a PSCCH, or may be a MAC CE or an RRC. This application is not limited thereto.

In some other embodiments, the fifth indication information is used to indicate that generation of the resource combination information or the first MAC CE is triggered based on an event. For example, the event includes but is not limited to a conflict between a resource of the second terminal and a resource of another terminal.

In some other embodiments, the fifth indication information is used to indicate that generation of the resource combination information or the first MAC CE is periodically triggered.

In some embodiments of this application, the first MAC CE further includes sixth indication information, and the sixth indication information is used to indicate a parameter based on which the resource combination information or the first MAC CE is generated.

In some embodiments, the sixth indication information may be at a granularity of a MAC CE. Optionally, in this case, an information field of the sixth indication information and an information field of the resource combination information may be independent information fields.

In some embodiments, the sixth indication information may be at a granularity of resource combination information. Optionally, in this case, the sixth indication information may be included in the information field of the resource combination information.

In some embodiments, the sixth indication information is used to indicate at least one of the following:
priority information of sidelink transmission, information about a frequency domain resource used for sidelink transmission, information about a quantity of sub-channels used for sidelink transmission, resource reservation interval information, and latency information of sidelink transmission.

In some embodiments, the sidelink transmission may include PSCCH and/or PSSCH transmission.

In some embodiments, the priority information of sidelink transmission includes priority information used for PSCCH and/or PSSCH transmission.

In some embodiments, the information about the frequency domain resource used for sidelink transmission may include the information about the quantity of sub-channels used for sidelink transmission.

In embodiments of this application, the first terminal indicates, to the second terminal, a parameter based on which the resource combination information or the first MAC CE is generated, so that the second terminal may determine a reference value of the N pieces of resource combination information according to the parameter, which is conducive to assisting the second terminal in selecting a proper resource.

In some embodiments of this application, the second terminal receives a signal based on discontinuous reception (DRX), and the first terminal may send the first MAC CE to the second terminal when the second terminal is in a DRX active time.

In some embodiments of this application, the first terminal sends the first MAC CE to the second terminal based on first duration or a first timer.

Optionally, the first duration or duration of the first timer may be determined according to configuration information.

Optionally, the configuration information includes at least one of the following: pre-configuration information, a system message, or dedicated signalling.

Optionally, the dedicated signalling may include but is not limited to RRC signalling or MAC signalling.

That is, the first duration or the duration of the first timer may be predefined, or a network device may configure the first duration or the duration of the first timer.

In some embodiments, the configuration information is configured for a granularity of a resource pool.

For example, the first duration or the duration of the first timer may be predefined for different resource pools, or the network device configures the first duration or the duration of the first timer for different resource pools.

In some embodiments of this application, that the first terminal sends the first MAC CE to the second terminal may be based on a request message from the second terminal, where the request message is used to request the first terminal to send the resource combination information to the second terminal. Alternatively, that the first terminal sends the first MAC CE to the second terminal may be triggered based on an event. For example, the event may include but is not limited to a conflict between a resource of the second terminal and a resource of another terminal.

Case 1: The first MAC CE is sent based on triggering of a request message from the second terminal.

In this case, the first terminal may send the first MAC CE to the second terminal based on the first duration or the first timer.

Further, optionally, the first terminal sends the first MAC CE to the second terminal within the first duration or during a running period of the first timer and when the second terminal is in the DRX active time.

Optionally, in a case in which the first duration is exceeded or the first timer expires, the first terminal does not send the first MAC CE, or drops the first MAC CE, or cancels the first MAC CE.

Optionally, if the first duration is exceeded or the first timer expires, it may be considered that the N pieces of resource combination information do not have a great reference value. For example, a latency requirement of sidelink transmission cannot be met. Therefore, the N pieces of resource combination information may not be indicated to the second terminal.

In some embodiments, the first terminal and the second terminal have a same understanding about a start time of the first duration or the first timer. For example, that the first terminal receives the request message from the second terminal is used as the start time of the first duration or the first timer.

In some embodiments, the request message is a physical control channel, for example, a PSCCH. In this case, the start time of the first duration or the first timer may be a time at which the physical control channel is received.

In some other embodiments, the request message is an RRC message or a MAC CE. In this case, a time of last transmission of the request message may be used as the start time, or a time at which acknowledgment (ACK) information corresponding to the request message is sent may be used as the start time.

Case 2: The first MAC CE is sent based on triggering of an event.

In this case, the first terminal may send the first MAC CE to the second terminal when the second terminal is in the DRX active time.

Further, optionally, the first terminal may send the first MAC CE to the second terminal within the first duration or during the running period of the first timer and when the second terminal is in the DRX active time.

Optionally, the start time of the first duration or the first timer may be an occurrence time of the event.

In conclusion, the first terminal sends the first MAC CE to the second terminal, and the first MAC CE includes N pieces of resource combination information, which are used to assist the second terminal in performing resource selection. This is conducive to selecting a more proper resource by the second terminal, thereby improving the performance of sidelink transmission.

For example, each piece of resource combination information in the first MAC CE includes information fields corresponding to TRIV information and FRIV information, or information fields corresponding to TRIV information, FRIV information, and resource reservation period information. Alternatively, first resource allocation information may be carried in the first MAC CE, that is, both an initial transmission resource and a retransmission resource that are used for sidelink transmission are indicated.

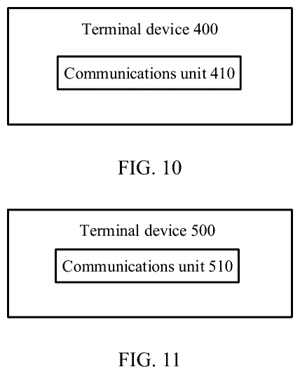

The foregoing describes method embodiments of this application in detail with reference to FIG. 4 to FIG. 9. The following describes apparatus embodiments of this application in detail with reference to FIG. 10 to FIG. 14. It should be understood that the apparatus embodiments are corresponding to the method embodiments. For similar descriptions, refer to the method embodiments.

FIG. 10 is a schematic block diagram of a terminal device 400 according to an embodiment of this application. As shown in FIG. 10, the terminal device 400 includes:
a communications unit 410, configured to send a first medium access control control element MAC CE to a second terminal, where the first MAC CE includes N pieces of resource combination information, the N pieces of resource combination information are used to assist the second terminal in performing resource selection, and the N is a positive integer.

In some embodiments, a length of the first MAC CE is determined according to a size of Nₘₐₓ pieces of resource combination information, where Nₘₐₓ is a maximum quantity of pieces of resource combination information.

In some embodiments, the length of the first MAC CE is variable.

In some embodiments, the length of the first MAC CE is determined according to a size of the N pieces of resource combination information, where N is less than or equal to Nₘₐₓ, and Nₘₐₓ is a maximum quantity of pieces of resource combination information.

In some embodiments, Nₘₐₓ is predefined or configured by a network device.

In some embodiments, Nₘₐₓ is configured for a granularity of a resource pool.

In some embodiments, the N pieces of resource combination information are successively included in the first MAC CE in a preset order.

In some embodiments, the N pieces of resource combination information are successively included in the first MAC CE in ascending order of signal quality.

In some embodiments, the resource combination information includes first time resource indicator value TRIV information and first frequency resource indicator value FRIV information.

In some embodiments, a length of an information field occupied by the first TRIV information is fixed, or the length of the information field occupied by the first TRIV information is variable.

In some embodiments, that the length of the information field occupied by the first TRIV information is variable includes:
the length of the information field occupied by the first TRIV information is determined according to configuration information.

In some embodiments, a length of an information field occupied by the first FRIV information is fixed, or the length of the information field occupied by the first FRIV information is variable.

In some embodiments, that the length of the information field occupied by the first FRIV information is variable includes:
the length of the information field occupied by the first FRIV information is determined according to configuration information.

In some embodiments, the resource combination information further includes resource reservation period information.

In some embodiments, a length of an information field occupied by the resource reservation period information is fixed, or the length of the information field occupied by the resource reservation period information is variable.

In some embodiments, that the length of the information field occupied by the resource reservation period information is variable includes:
the length of the information field occupied by the resource reservation period information is determined according to configuration information.

In some embodiments, the first MAC CE includes first indication information, and the first indication information is used to indicate whether all pieces of resource combination information in the first MAC CE each include resource reservation period information; or
the first MAC CE includes second indication information corresponding to each piece of resource combination information among the N pieces of resource combination information, and the second indication information corresponding to each piece of resource combination information is used to indicate whether the resource combination information includes resource reservation period information.

In some embodiments, the first MAC CE further includes at least one piece of first resource allocation information.

In some embodiments, the first MAC CE includes M pieces of first resource allocation information, the M pieces of first resource allocation information correspond to the N pieces of resource combination information, M is a positive integer, and M is less than or equal to N.

In some embodiments, the first resource allocation information includes second TRIV information and second FRIV information; or
the first resource allocation information includes second TRIV information, second FRIV information, and resource reservation period information.

In some embodiments, the resource combination information includes first resource allocation information and second resource allocation information, and a resource indicated by the first resource allocation information is earlier than a resource indicated by the second resource allocation information.

In some embodiments, the first resource allocation information is used to determine an initial transmission resource used for sidelink transmission, and the second resource allocation information is used to determine a retransmission resource used for sidelink transmission;
where the second resource allocation information includes first TRIV information and first FRIV information; or
the second resource allocation information includes first TRIV information, first FRIV information, and resource reservation period information.

In some embodiments, the first resource allocation information includes first time offset information, and the first time offset information is a time offset relative to a time domain resource indicated by the first TRIV information.

In some embodiments, the first resource allocation information includes third TRIV information and/or third FRIV information.

In some embodiments, a manner in which the first resource allocation information is carried in the first MAC CE is determined by using configuration information.

In some embodiments, the first MAC CE further includes third indication information, and the third indication information is used to indicate that a resource indicated by the N pieces of resource combination information is a preferred resource or a non-preferred resource; or
the first MAC CE includes fourth indication information corresponding to each piece of resource combination information among the N pieces of resource combination information, and the fourth indication information corresponding to each piece of resource combination information is used to indicate that a resource indicated by the piece of resource combination information is a preferred resource or a non-preferred resource.

In some embodiments, that resources indicated by the N pieces of resource combination information are preferred resources or non-preferred resources is determined according to configuration information.

In some embodiments, the first MAC CE further includes fifth indication information, and the fifth indication information is used to indicate a trigger condition of generating the resource combination information or the first MAC CE.

In some embodiments, the fifth indication information is used to indicate that generation of the resource combination information or the first MAC CE is triggered based on a request from the second terminal; or
the fifth indication information is used to indicate that generation of the resource combination information or the first MAC CE is triggered based on an event; or
the fifth indication information is used to indicate that generation of the resource combination information or the first MAC CE is periodically triggered.

In some embodiments, the first MAC CE further includes sixth indication information, and the sixth indication information is used to indicate a parameter based on which the resource combination information or the first MAC CE is generated.

In some embodiments, the sixth indication information is used to indicate at least one of the following:
priority information of sidelink transmission, information about a frequency domain resource used for sidelink transmission, information about a quantity of sub-channels used for sidelink transmission, resource reservation interval information, and latency information of sidelink transmission.

In some embodiments, the communications unit 410 is further configured to:
send the first MAC CE to the second terminal when the second terminal is in a discontinuous reception DRX active time.

In some embodiments, the communications unit 410 is further configured to:
within first duration or during a running period of a first timer and in a case in which the second terminal is in the DRX active time, send the first MAC CE to the second terminal; or
in a case in which the first duration is exceeded or the first timer expires, skip sending the first MAC CE.

In some embodiments, the first MAC CE is sent based on triggering of an event.

In some embodiments, the communications unit 410 is further configured to: send the first MAC CE to the second terminal based on first duration or a first timer.

In some embodiments, the communications unit 410 is further configured to:
within the first duration or during a running period of the first timer and in a case in which the second terminal is in a DRX active time, send the first MAC CE to the second terminal; or
in a case in which the first duration is exceeded or the first timer expires, skip sending the first MAC CE.

In some embodiments, the first duration or the first timer uses that the terminal device receives a request message from the second terminal as a start time, and the request message is used to request the terminal device to send the resource combination information to the second terminal.

In some embodiments, the request message is a physical sidelink control channel.

In some embodiments, the request message is a MAC CE or a radio resource control RRC message.

In some embodiments, that the first duration or the first timer uses that the terminal device receives a request message of the second terminal as a start time includes:
a time of last transmission of the request message is used as the start time; or
a time at which acknowledgment ACK information corresponding to the request message is sent is used as the start time.

In some embodiments, the configuration information includes at least one of the following: pre-configuration information, a system message, or dedicated signalling.

In some embodiments, the configuration information is configured for a granularity of a resource pool.

Optionally, in some embodiments, the foregoing communications unit may be a communications interface or a transceiver, or an input/output interface of a communications chip or a system-on-chip. The foregoing processing unit may be one or more processors.

It should be understood that the terminal device 400 according to this embodiment of this application may correspond to a first terminal in the method embodiments of this application, and the foregoing and other operations and/or functions of units in the terminal device 400 are respectively used to implement corresponding procedures of the first terminal in the method 200 shown in FIG. 4 to FIG. 9. For brevity, details are not described herein again.

FIG. 11 is a schematic block diagram of a terminal device according to an embodiment of this application. The terminal device 500 in FIG. 11 includes:
a communications unit 510, configured to receive a first medium access control control element MAC CE sent by a first terminal, where the first MAC CE includes N pieces of resource combination information, the N pieces of resource combination information are used to assist the terminal device in performing resource selection, and the N is a positive integer.

In some embodiments, a length of the first MAC CE is determined according to a size of Nₘₐₓ pieces of resource combination information, where Nₘₐₓ is a maximum quantity of pieces of resource combination information.

In some embodiments, the length of the first MAC CE is variable.

In some embodiments, the length of the first MAC CE is determined according to a size of the N pieces of resource combination information, where N is less than or equal to Nₘₐₓ, and Nₘₐₓ is a maximum quantity of pieces of resource combination information.

In some embodiments, Nₘₐₓ is predefined or configured by a network device.

In some embodiments, Nₘₐₓ is configured for a granularity of a resource pool.

In some embodiments, the N pieces of resource combination information are successively included in the first MAC CE in a preset order.

In some embodiments, the N pieces of resource combination information are successively included in the first MAC CE in ascending order of signal quality.

In some embodiments, the resource combination information includes first time resource indicator value TRIV information and first frequency resource indicator value FRIV information.

In some embodiments, a length of an information field occupied by the first TRIV information is fixed, or the length of the information field occupied by the first TRIV information is variable.

In some embodiments, that the length of the information field occupied by the first TRIV information is variable includes:
the length of the information field occupied by the first TRIV information is determined according to configuration information.

In some embodiments, a length of an information field occupied by the first FRIV information is fixed, or the length of the information field occupied by the first FRIV information is variable.

In some embodiments, that the length of the information field occupied by the first FRIV information is variable includes:
the length of the information field occupied by the first FRIV information is determined according to configuration information.

In some embodiments, the resource combination information further includes resource reservation period information.

In some embodiments, a length of an information field occupied by the resource reservation period information is fixed, or the length of the information field occupied by the resource reservation period information is variable.

In some embodiments, that the length of the information field occupied by the resource reservation period information is variable includes:
the length of the information field occupied by the resource reservation period information is determined according to configuration information.

In some embodiments, the first MAC CE includes first indication information, and the first indication information is used to indicate whether all pieces of resource combination information in the first MAC CE each include resource reservation period information; or
the first MAC CE includes second indication information corresponding to each piece of resource combination information among the N pieces of resource combination information, and the second indication information corresponding to each piece of resource combination information is used to indicate whether the piece of resource combination information includes resource reservation period information.

In some embodiments, the first MAC CE further includes at least one piece of first resource allocation information.

In some embodiments, the first MAC CE includes M pieces of first resource allocation information, the M pieces of first resource allocation information correspond to the N pieces of resource combination information, M is a positive integer, and M is less than or equal to N.

In some embodiments, the first resource allocation information includes second TRIV information and second FRIV information; or
the first resource allocation information includes second TRIV information, second FRIV information, and resource reservation period information.

In some embodiments, the resource combination information includes first resource allocation information and second resource allocation information, and a resource indicated by the first resource allocation information is earlier than a resource indicated by the second resource allocation information.

In some embodiments, the first resource allocation information is used to determine an initial transmission resource used for sidelink transmission, and the second resource allocation information is used to determine a retransmission resource used for sidelink transmission,
where the second resource allocation information includes first TRIV information and first FRIV information; or
the second resource allocation information includes first TRIV information, first FRIV information, and resource reservation period information.

In some embodiments, the first resource allocation information includes first time offset information, and the first time offset information is a time offset relative to a time domain resource indicated by the first TRIV information.

In some embodiments, the first resource allocation information includes third TRIV information and/or third FRIV information.

In some embodiments, a manner in which the first resource allocation information is carried in the first MAC CE is determined by using configuration information.

In some embodiments, the first MAC CE further includes third indication information, and the third indication information is used to indicate that a resource indicated by the N pieces of resource combination information is a preferred resource or a non-preferred resource; or
the first MAC CE includes fourth indication information corresponding to each piece of resource combination information among the N pieces of resource combination information, and the fourth indication information corresponding to each piece of resource combination information is used to indicate that a resource indicated by the piece of resource combination information is a preferred resource or a non-preferred resource.

In some embodiments, that resources indicated by the N pieces of resource combination information are preferred resources or non-preferred resources is determined according to configuration information.

In some embodiments, the first MAC CE further includes fifth indication information, and the fifth indication information is used to indicate a trigger condition of generating the resource combination information or the first MAC CE.

In some embodiments, the fifth indication information is used to indicate that generation of the resource combination information or the first MAC CE is triggered based on a request from the terminal device; or
the fifth indication information is used to indicate that generation of the resource combination information or the first MAC CE is triggered based on an event; or
the fifth indication information is used to indicate that generation of the resource combination information or the first MAC CE is periodically triggered.

In some embodiments, the first MAC CE further includes sixth indication information, and the sixth indication information is used to indicate a parameter based on which the resource combination information or the first MAC CE is generated.

In some embodiments, the sixth indication information is used to indicate at least one of the following:
priority information of sidelink transmission, information about a frequency domain resource used for sidelink transmission, information about a quantity of sub-channels used for sidelink transmission, resource reservation interval information, and latency information of sidelink transmission.

In some embodiments, the communications unit 510 is further configured to:
receive the first MAC CE sent by the first terminal when the terminal device is in a discontinuous reception DRX active time.

In some embodiments, the communications unit 510 is further configured to: within first duration or during a running period of a first timer and in a case in which the terminal device is in a DRX active time, receive the first MAC CE sent by the first terminal.

In some embodiments, the first MAC CE is sent based on triggering of an event.

In some embodiments, the communications unit 510 is further configured to: receive the first MAC CE based on first duration or a first timer.

In some embodiments, the communications unit 510 is further configured to: within the first duration or during a running period of the first timer and in a case in which the terminal device is in a DRX active time, receive the first MAC CE.

In some embodiments, the first duration or the first timer uses that the terminal device sends a request message to the first terminal as a start time, and the request message is used to request the first terminal to send the resource combination information to the terminal device.

In some embodiments, the request message is a physical sidelink control channel.

In some embodiments, the request message is a MAC CE or a radio resource control RRC message.

In some embodiments, that the first duration or the first timer uses that the terminal device sends a request message to the first terminal as a start time includes: a time of last transmission of the request message is used as the start time; or
a time at which acknowledgment ACK information corresponding to the request message is received is used as the start time.

In some embodiments, the configuration information includes at least one of the following: pre-configuration information, a system message, or dedicated signalling.

In some embodiments, the configuration information is configured for a granularity of a resource pool.

Optionally, in some embodiments, the foregoing communications unit may be a communications interface or a transceiver, or an input/output interface of a communications chip or a system-on-chip. The foregoing processing unit may be one or more processors.

It should be understood that the terminal device 500 according to this embodiment of this application may correspond to a second terminal in the method embodiments of this application, and the foregoing and other operations and/or functions of units in the terminal device 500 are respectively used to implement corresponding procedures of the second terminal in the method 200 shown in FIG. 4 to FIG. 9. For brevity, details are not described herein again.

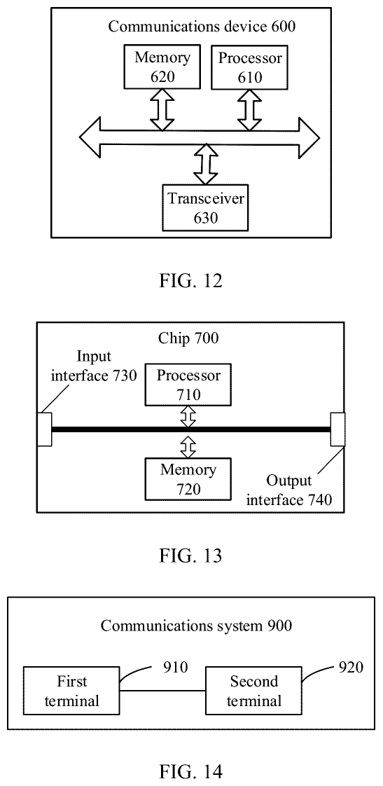

FIG. 12 is a schematic structural diagram of a communications device 600 according to an embodiment of this application. The communications device 600 shown in FIG. 12 includes a processor 610, and the processor 610 may invoke a computer program from a memory and run the computer program to implement a method in embodiments of this application.

As shown in FIG. 12, the communications device 600 may further include a memory 620. The processor 610 may invoke a computer program from the memory 620 and run the computer program to implement a method in embodiments of this application.

The memory 620 may be a separate component independent of the processor 610, or may be integrated into the processor 610.

In some embodiments, as shown in FIG. 12, the communications device 600 may further include a transceiver 630. The processor 610 may control the transceiver 630 to communicate with another device, and specifically, may send information or data to the another device or receive information or data sent by the another device.

The transceiver 630 may include a transmitter and a receiver. The transceiver 630 may further include an antenna, and a quantity of the antenna may be one or more.

Optionally, the communications device 600 may specifically be a first terminal in embodiments of this application, and the communications device 600 may implement corresponding procedures implemented by a first terminal in the methods according to embodiments of this application. For brevity, details are not described herein again.

Optionally, the communications device 600 may specifically be a second terminal in embodiments of this application, and the communications device 600 may implement corresponding procedures implemented by a second terminal in the methods according to embodiments of this application. For brevity, details are not described herein again.

FIG. 13 is a schematic structural diagram of a chip according to an embodiment of this application. The chip 700 shown in FIG. 13 includes a processor 710, and the processor 710 may invoke a computer program from a memory and run the computer program to implement a method in embodiments of this application.

Optionally, as shown in FIG. 13, the chip 700 may further include a memory 720. The processor 710 may invoke a computer program from the memory 720 and run the computer program to implement a method in embodiments of this application.

The memory 720 may be a separate component independent of the processor 710, or may be integrated into the processor 710.

Optionally, the chip 700 may further include an input interface 730. The processor 710 may control the input interface 730 to communicate with another device or chip, and specifically, may obtain information or data sent by the another device or chip.

Optionally, the chip 700 may further include an output interface 740. The processor 710 may control the output interface 740 to communicate with another device or chip, and specifically, may output information or data to the another device or chip.

Optionally, the chip may be applied to a first terminal in embodiments of this application, and the chip may implement corresponding procedures implemented by a first terminal in the methods according to embodiments of this application. For brevity, details are not described herein again.

Optionally, the chip may be applied to a second terminal in embodiments of this application, and the chip may implement corresponding procedures implemented by a second terminal in the methods according to embodiments of this application. For brevity, details are not described herein again.

It should be understood that the chip mentioned in this embodiment of this application may also be referred to as a system-level chip, a system chip, a chip system, or a system-on-chip.

FIG. 14 is a schematic block diagram of a communications system 900 according to an embodiment of this application. As shown in FIG. 14, the communications system 900 includes a first terminal 910 and a second terminal 920.

The first terminal 910 may be configured to implement corresponding functions implemented by a first terminal in the foregoing methods, and the second terminal 920 may be configured to implement corresponding functions implemented by a second terminal in the foregoing methods. For brevity, details are not described herein again.

It should be understood that, a processor in embodiments of this application may be an integrated circuit chip having a signal processing capability. In an implementation process, the steps in the foregoing method embodiments may be performed by using an integrated logic circuit of hardware of the processor or instructions in a software form. The processor may be a general-purpose processor, a digital signal processor (DSP), an application-specific integrated circuit (ASIC), a field programmable gate array (FPGA) or another programmable logic device, a discrete gate or a transistor logic device, or a discrete hardware component. The processor can implement or perform the methods, steps and logical block diagrams disclosed in embodiments of this application. The general-purpose processor may be a microprocessor, or the processor may be any conventional processor or the like. The steps of methods disclosed with reference to embodiments of this application may be directly implemented by a hardware decoding processor, or may be implemented by a combination of hardware and software modules in a decoding processor. The software module may be located in a mature storage medium in the art, for example, a random access memory, a flash memory, a read-only memory, a programmable read-only memory, an erasable programmable memory, or a register. The storage medium is located in a memory. The processor reads information from the memory, and completes the steps of the foregoing methods in combination with hardware in the processor.

It may be understood that the memory in embodiments of this application may be a volatile memory or a non-volatile memory, or may include both a volatile memory and a non-volatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), and is used as an external cache. By way of example but not limitative description, many forms of RAMs may be used, for example, a static random access memory (SRAM), a dynamic random access memory (DRAM), a synchronous dynamic random access memory (SDRAM), a double data rate synchronous dynamic random access memory (DDR SDRAM), an enhanced synchronous dynamic random access memory (ESDRAM), a synchlink dynamic random access memory (SLDRAM), and a direct Rambus random access memory (DR RAM). It should be noted that, the memory in the system and methods described in this specification includes but is not limited to these memories and any memory of another proper type.

It should be understood that, by way of example but not limitative description, for example, the memory in embodiments of this application may alternatively be a static random access memory (SRAM), a dynamic random access memory (DRAM), a synchronous dynamic random access memory (SDRAM), a double data rate synchronous dynamic random access memory (DDR SDRAM), an enhanced synchronous dynamic random access memory (ESDRAM), a synchlink dynamic random access memory (SLDRAM), a direct Rambus random access memory (DR RAM), or the like. In other words, the memory in embodiments of this application includes but is not limited to these memories and any memory of another proper type.

An embodiment of this application further provides a computer-readable storage medium, configured to store a computer program.

Optionally, the computer-readable storage medium may be applied to a first terminal in embodiments of this application, and the computer program causes a computer to execute a corresponding procedure implemented by a first terminal device in the methods according to embodiments of this application. For brevity, details are not described herein again.

Optionally, the computer-readable storage medium may be applied to a second terminal in embodiments of this application, and the computer program causes a computer to execute a corresponding procedure implemented by a second terminal in the methods according to embodiments of this application. For brevity, details are not described herein again.

An embodiment of this application further provides a computer program product, including computer program instructions.

Optionally, the computer program product may be applied to a first terminal in embodiments of this application, and the computer program instructions cause the computer to execute a corresponding procedure implemented by a first terminal in the methods according to embodiments of this application. For brevity, details are not described herein again.

Optionally, the computer program product may be applied to a second terminal in embodiments of this application, and the computer program instructions cause the computer to execute a corresponding procedure implemented by a second terminal in the methods according to embodiments of this application. For brevity, details are not described herein again.

An embodiment of this application further provides a computer program.

Optionally, the computer program may be applied to a first terminal in embodiments of this application. When the computer program runs on a computer, the computer executes corresponding procedures implemented by a first terminal in the methods according to embodiments of this application. For brevity, details are not described herein again.

Optionally, the computer program may be applied to a second terminal in embodiments of this application. When the computer program runs on the computer, the computer executes corresponding procedures implemented by a second terminal in the methods according to embodiments of this application. For brevity, details are not described herein again.

A person of ordinary skill in the art may be aware that, units and algorithm steps in examples described in combination with embodiments disclosed in this specification can be implemented by electronic hardware or a combination of computer software and electronic hardware. Whether the functions are performed by hardware or software depends on particular applications and design constraints of the technical solutions. A person skilled in the art may use different methods to implement the described functions for each particular application, but it should not be considered that the implementation goes beyond the scope of this application.

It may be clearly understood by a person skilled in the art that, for the purpose of convenient and brief description, for a detailed working process of the foregoing system, apparatus, and unit, refer to corresponding processes in the foregoing method embodiments, and details are not described herein again.

In the several embodiments provided in this application, it should be understood that the disclosed system, apparatus, and method may be implemented in another manner. For example, the described apparatus embodiments are merely examples. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatus or units may be implemented in electronic, mechanical, or other forms.

The units described as separate components may be or may not be physically separated, and the components displayed as units may be or may not be physical units, that is, may be located in one place or distributed on a plurality of network units. Some or all of the units may be selected according to actual needs to achieve the objective of the solutions of embodiments.

In addition, function units in embodiments of this application may be integrated into one processing unit, or each of the units may exist alone physically, or two or more units may be integrated into one unit.

When the functions are implemented in a form of a software function unit and sold or used as an independent product, the functions may be stored in a computer-readable storage medium. Based on such an understanding, the technical solutions in embodiments of this application essentially, or the part contributing to the prior art, or some of the technical solutions may be implemented in a form of a software product. The computer software product is stored in a storage medium and includes several instructions for instructing a computer device (which may be a personal computer, a server, a network device, or the like) to execute all or some of the steps of the methods in embodiments of this application. The foregoing storage medium includes various media that may store a program code, such as a USB flash drive, a removable hard disk, a read-only memory (ROM), a random access memory (RAM), a magnetic disk, or an optical disk.

The foregoing descriptions are merely specific implementations of this application, but the protection scope of this application is not limited thereto. Any variation or replacement readily figured out by a person skilled in the art within the technical scope disclosed in this application shall fall within the protection scope of this application. Therefore, the protection scope of this application should be subject to the protection scope of the claims.

What is claimed is:

1. A wireless communication method, comprising:
sending, by a first terminal, a first medium access control control element (MAC CE) to a second terminal, wherein the first MAC CE comprises N pieces of resource combination information, the N pieces of resource combination information are used to assist the second terminal in performing resource selection, and N is a positive integer.

2. The method according to claim 1, wherein a length of the first MAC CE is variable.

3. The method according to claim 1, wherein the first MAC CE further comprises at least one piece of first resource allocation information.

4. The method according to claim 3, wherein the first MAC CE comprises M pieces of first resource allocation information, the M pieces of first resource allocation information correspond to the N pieces of resource combination information, M is a positive integer, and M is less than or equal to N.

5. The method according to claim 4, wherein the first resource allocation information comprises first time offset information, and the first time offset information is a time offset relative to a time domain resource indicated by first time resource indicator value (TRIV) information.

6. The method according to claim 1, wherein the first MAC CE further comprises third indication information, and the third indication information is used to indicate that resources indicated by the N pieces of resource combination information are preferred resources or non-preferred resources.

7. The method according to claim 1, wherein the sending, by a first terminal, a first medium access control control element (MAC CE) to a second terminal comprises:
sending, by the first terminal, the first MAC CE to the second terminal based on a first timer.

8. The method according to claim 7, wherein a time when the first terminal receives a request message from the second terminal is used as a start time of the first timer.

9. The method according to claim 7, wherein in a case that the first timer expires, the first terminal cancels the first MAC CE.

10. A terminal device, comprising a processor and a memory, wherein the memory is configured to store a computer program, and the processor is configured to invoke and run the computer program stored in the memory to cause the terminal device to perform:
sending a first medium access control control element (MAC CE) to a second terminal, wherein the first MAC CE comprises N pieces of resource combination information, the N pieces of resource combination information are used to assist the second terminal in performing resource selection, and N is a positive integer.

11. The terminal device according to claim 10, wherein a length of the first MAC CE is variable.

12. The terminal device according to claim 10, wherein the first MAC CE further comprises at least one piece of first resource allocation information.

13. The terminal device according to claim 12, wherein the first MAC CE comprises M pieces of first resource allocation information, the M pieces of first resource allocation information correspond to the N pieces of resource combination information, M is a positive integer, and M is less than N.

14. The terminal device according to claim 13, wherein the first resource allocation information comprises first time offset information, and the first time offset information is a time offset relative to a time domain resource indicated by first time resource indicator value (TRIV) information.

15. The terminal device according to claim 10, wherein the first MAC CE further comprises third indication information, and the third indication information is used to indicate that resources indicated by the N pieces of resource combination information are preferred resources or non-preferred resources.

16. The terminal device according to claim 10, wherein the sending a first medium access control control element (MAC CE) to a second terminal comprises:
sending the first MAC CE to the second terminal based on a first timer.

17. The terminal device according to claim 16, wherein a time when the terminal device receives a request message from the second terminal is used as a start time of the first timer.

18. The terminal device according to claim 16, wherein in a case that the first timer expires, the terminal device cancels the first MAC CE.

19. A terminal device, comprising a processor and a memory, wherein the memory is configured to store a computer program, and the processor is configured to invoke and run the computer program stored in the memory to cause the terminal device to perform:
receiving a first medium access control control element (MAC CE) sent by a first terminal, wherein the first MAC CE comprises N pieces of resource combination information, the N pieces of resource combination information are used to assist the terminal device in performing resource selection, and N is a positive integer.

20. The terminal device according to claim 19, wherein a length of the first MAC CE is variable.
